(19) United States
(12) Patent Application Publication
(10) Pub. No.: US 2006/0275558 A1
(43) Pub. Date: Dec. 7, 2006

(54) Conductively coated substrates derived from biaxially-oriented and heat-set polyester film

(76) Inventors: Thomas Joseph Pecorini, Kingsport, TN (US); Sam Richard Turner, Blacksburg, VA (US); Brian Michael King, Jonesborough, TN (US); Christopher Moore Killian, Gray, TN (US); Crystal Leigh Kendrick, Kingsport, TN (US); Peter Borden Mackenzie, Murrysville, PA (US)

Correspondence Address: B. J. Boshears;Eastman Chemical Company, P.O. Box 511, Kingsport, TN, 37662-5075, US

(21) Appl. No.: 11/431,238

(22) Filed: May 10, 2006

Related U.S. Application Data
(60) Provisional application No. 60/681,647, filed on May 17, 2005.

(51) Int. Cl. C09K 19/00; B32B 27/36

(52) U.S. Cl. 428/1.6; 428/480; 428/702; 428/910

(57) ABSTRACT

Described are films capable of being coated with a conductive coating at temperatures equal to or greater than 240° C., said film comprising a biaxially-oriented polyester film that is produced from a polyester having a melting point of 260° C. or greater.

### CROSS-REFERENCE TO RELATED APPLICATION

This application claims priority under 35 U.S.C. § 119(e) to U.S. Provisional Application Ser. No. 60/681,647 filed on May 17, 2005, which is hereby incorporated by this reference in its entirety.

### FIELD OF THE INVENTION

This invention generally pertains to thermally-stable polyester films that can be coated with conductive coatings to produce a conductively coated substrate suitable for use in a variety of electronic applications including but not limited to liquid crystal displays, organic light emitting diodes, photovoltaic devices, RFID labels, and electrophoretic displays. More specifically, the invention pertains to thermally-stable polyester films produced from poly(1,4-cyclohexylenedimethylene terephthalate) (PCT) or poly(1,4-cyclohexylenedimethylene naphthalenedicarboxylate) (PCN) homo- or copolyester or blends thereof, which are biaxially-oriented or stretched, heat-set, and then used to produce conductively coated substrates.

### BACKGROUND OF THE INVENTION

Poly(ethylene terephthalate) (PET) films are widely used for a variety of wrapping, packaging, and lamination applications. PET films are sometimes used in shrink-wrap applications in which the film is applied to an object and heated so that the film shrinks around the object. In other applications such as flexible electronic circuits, touch screen displays, and flexible photovoltaic devices, biaxially-oriented and heat-set PET films having good dimensional stability and shrink resistance at elevated temperatures are used. However, biaxially-oriented PET films are not believed to be useful at temperatures exceeding 200° C. because of their low Tg (˜80° C.) and relatively low inherent melting temperature (Tm) (approximately 250° C.).

It is generally known in the art that biaxially-oriented PET and biaxially-oriented poly(ethylene naphthalate) (PEN) have been used as substrate films for indium tin oxide (ITO) coated transparent conductive substrates. Although adequate for many applications, PET and PEN films are believed to lack temperature dimensional stability needed for the high temperature deposition of ITO often necessary to prepare a conductively coated substrate for use in applications where high transparency and good conductivity are desirable, such as in flat panel displays and photovoltaic devices. Higher temperatures are believed to be necessary to reduce the thickness of the ITO coating for a given conductivity. Reduced thickness coatings can resist fracture when bent, and there is a need in many existing and emerging applications for increased durability and flexible form factors while maintaining high transparency and adequate conductivity. These applications include flat panel displays, photovoltaic devices, and flexible displays among others. In addition, it has been reported that for high transparency/high conductivity films requiring patterning via a post-deposition etching process, ITO coated films where the deposition and annealing were done at greater than 200° C. result in conductive substrates with superior pattern definition relative to films where the ITO was applied and annealed at temperatures less than 200° C.

The desirable properties of a transparent conductively coated substrate include at least one of the following: transparency, conductivity, flexibility, charge carrier density, charge carrier mobility, tensile and flexural properties, hydrolytic stability, and dimensional stability. The current materials (PET, PEN, polyimide, glass, etc . . . ) known in the art for use in transparent conductively coated substrates are believed to be deficient in one or more of the aforementioned properties. To achieve superior conductivity performance while maintaining transparency, flexibility, and substrate durability; a material with greater temperature dimensional stability than PET and PEN is needed; a material with improved durability and flexibility to glass is needed; and a material with improved transparency to polyimide is needed.

Certain applications, such as transparent conductively coated substrates, would benefit from or even require films that are heat stable (i.e., possessing good dimensional stability) at temperatures greater than or equal to 240° C. Specifically, the films should not blister or wrinkle when coated with ITO and/or other inorganic oxide at temperatures greater than 240° C. Preferably, the films should not blister or lose dimensional stability when coated with ITO at temperatures greater than 250° C.

In addition to transparent inorganic oxide coatings of the type described above, amorphous silicon and polycrystalline silicon are often used as the conductive coating for high-end display applications including active matrix TFT displays. The vapor deposition of amorphous silicon on glass is carried out at temperatures greater than 350° C. In recent years, however, lower temperature amorphous silicon and polycrystalline silicon deposition processes have been developed with deposition being carried out between 200° C. and 350° C., or between 225° C. and 300° C. Even with the progress in lowering the required deposition temperature for amorphous and polycrystalline silicon, very few plastics can withstand these deposition temperatures. Therefore, a new polymer film is needed that has the requisite dimensional stability along with good light transparency and a low coefficient of thermal expansion (CTE).

Superior hydrolytic stability is another desirable property for films used as conductively coated substrates across a variety of applications. Therefore, base films with superior hydrolytic stability for producing conductively coated substrates, which tend to maintain their structural integrity under high temperature and high humidity conditions, are also needed.

### SUMMARY OF THE INVENTION

It is believed that the films of the invention comprising (a) diacid residues comprising from about 90 to about 100 mole percent of terephthalic acid residues, naphthalenedicarboxylic acid residues, 4,4′-biphenyldicarboxylic acid, or combinations thereof; and (b) diol residues comprising at least 90 mole percent of 1,4-cyclohexanedimethanol residues are superior to films in the art which comprise conductively coated substrates with respect to at least one of the following: transparency, conductivity, flexibility, charge carrier density, tensile and flexural properties, hydrolytic stability, substrate durability, slow crystallization rates, and dimensional stability.

These films are believed to be superior to PET and PEN in temperature dimensional stability, superior to glass in durability and flexibility, and superior in transparency to polyimides.

These films comprise polyesters having slow crystallization properties that result in a greater ability to produce amorphous finished articles. In one embodiment, the films of the invention have slow crystallization rates prior to heatsetting. In another embodiment, the heatset films of the invention can be crystalline or semi-crystalline.

In one embodiment, the films of the invention are capable of being coated with ITO and/or at least one other inorganic oxide at temperatures greater than or equal to 240° C. In another embodiment, the films of the invention comprise transparent conductively coated substrates which are heat stable (i.e., possessing good dimensional stability) at temperatures greater than or equal to 240° C. In other embodiments, the films of the invention comprising transparent conductively coated substrates are heat stable when coated with ITO and/or at least one other inorganic oxide at temperatures as follows: from 240° C. to 310° C. or 240° C. to 290° C. In another embodiment, the films of the invention are capable of being coated with a conductively coated substrates at temperatures greater than 250° C. In other embodiments, the films of the invention comprise transparent conductively coated substrates which are heat stable when coated with ITO at temperatures greater than 250° C. In other embodiments, the films of the invention comprise transparent conductively coated substrates which are heat stable when coated with ITO and/or at least one other inorganic oxide at temperatures as follows: from 250° C. to 310° C. or 250° C. to 290° C. In other embodiments, the films as described herein when used in conductively coated substrates do not blister or wrinkle and/or lose dimensional stability at the temperatures described herein.

In one aspect, the invention provides for a film comprising a biaxially-oriented polyester film that is produced from a polyester having a melting point (Tm) of 260° C. or greater. Melting points were measured herein using differential scanning calorimetry (DSC) in accordance with ASTM D3418. In one embodiment, the polyester comprises (a) diacid residues comprising from about 90 to about 100 mole percent, but in another embodiment, 99.5 to 100 mole percent of terephthalic acid residues, naphthalenedicarboxylic acid residues, 4,4′-biphenyldicarboxylic acid, or combinations thereof; and (b) diol residues comprising at least 90 mole percent of 1,4-cyclohexanedimethanol residues. The polyester comprises a total of 100 mole percent of diacid residues and a total of 100 mole percent of diol residues.

In another embodiment, the polyester film has been stretched biaxially at conditions that satisfy the equation (27*R)−(1.3*(T−Tg))≧27, where T is the average of the machine and transverse direction stretch temperatures in degrees Celsius, Tg is the glass transition temperature of the polymer film in degrees Celsius, and R is the average of the machine and transverse direction stretch ratios; and has been heat-set at an actual film temperature of from 250° C. to Tm, where Tm is the melting point of the polymer.

In a second aspect, the invention provides for a transparent conductively coated substrate comprising (a) a transparent conductive inorganic oxide coating and (b) a biaxially-oriented polyester film as described herein.

In a third aspect, the invention provides for a conductively coated substrate comprising (a) an amorphous silicon or polycrystalline silicon conductive coating and (b) a biaxially-oriented polyester film as described herein.

The substrates according to the invention can be used in a variety of applications including, but not limited to, a liquid crystal display assembly, an organic light emitting diode display assembly, a photovoltaic device assembly, an architectural window or glazing, and a touch screen display.

### DETAILED DESCRIPTION OF THE INVENTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

In order to coat a film at elevated temperatures such as 240° C. or 250° C., the polymer making up the film should have a melting point above 260° C., preferably above 270° C. If it does not have a melting point at least 10° C. higher than the coating temperature, the polymer can melt during the coating process. Higher melting point materials are capable of being coated at higher temperatures.

A particular film of the invention that meets these criteria can be produced from a polyester comprising:

(1) diacid residues comprising from about 90 to about 99.5 mole percent of terephthalic acid residues, naphthalenedicarboxylic acid residues, or combinations thereof; and

(2) diol residues comprising at least 90 mole percent of 1,4-cyclohexanedimethanol residues; wherein the polyester comprises a total of 100 mole percent diacid residues and a total of 100 mole percent diol residues, and a melting point of 260° C. or greater, and preferably 270° C. or greater.

In addition, such a film should be biaxially stretched and heat-set at or above 250° C. If during heat-set, the stretched film does not reach the temperature at which the coating step will eventually be performed, it may not have sufficient dimensional stability during the conductive inorganic oxide coating process.

Preferably, the film is stretched or oriented at stretch ratios above 2.0× and at stretch temperatures above 90° C. More preferably, the film is stretched at conditions that satisfy the equation (27*R)−(1.3*(T−Tg))≧27, where T is the average of the machine and transverse direction stretch temperatures in degrees Celsius, Tg is the glass transition temperature of the polymer film in degrees Celsius, and R is the average of the machine and transverse direction stretch ratios. Most preferably, the film is stretched between 2.5 and 3.0× at temperatures between Tg and Tg+20° C., and then heat-set at an actual film temperature of from 250° C. to Tm, or from 260° C. to Tm, where Tm is the melting point of the polymer, for 1 to 120 seconds, or for 1 to 60 seconds, while maintaining the dimensions of the stretched film. It is preferred that the biaxially-oriented and heat-set polyester film has dimensional stability at temperatures >240° C. and exhibits a coefficient of thermal expansion value such that delaminating or cracking of the inorganic oxide coating does not occur during use of the resulting conductively coated substrate or in the preparation and/or curing of the conductive coating. Preferred coefficient of thermal expansion is between 10 and 50 ppm when measured between 20 and 90° C.

A conductive coating may be applied onto a film according to the invention to form a substrate. The conductive coating can be applied by a number of processes well known in the art including sputtering, chemical vapor deposition, electron beam evaporation, pulsed laser deposition, and plasma-enhanced chemical vapor deposition, among others. The conductive coating can be deposited over a range of multiple thicknesses, and the conductively coated substrate can optionally be coated with an oxygen and/or moisture barrier layer.

The “conductive coating” refers to a transparent conductive inorganic oxide layer, or an amorphous or polycrystalline silicon layer. The “transparent conductive inorganic oxide layer” is commonly known in the art and can include but is not limited to tin oxide, indium tin oxide (ITO), zinc oxide, indium oxide, tin-antimony composite oxide, indium-zinc composite oxide, zinc-aluminum composite oxide, and derivatives thereof.

The polyesters used to prepare the films in the present invention can be readily prepared by conventional methods well known in the art. For example, melt-phase or a combination of melt-phase and solid-phase polycondensation techniques may be used if desired. The polyesters typically have an inherent viscosity (I.V.) of about 0.4 to 1.2, preferably about 0.5 to 1.1. Films at an I.V. less than 0.5 may experience a reduction in toughness when the final biaxially stretched film is creased. As used herein, I.V. refers to viscosity determinations made at 25° C. using 0.50 gram of polymer per 100 mL of a solvent composed of 60 weight percent phenol and 40 weight percent tetrachloroethane. The basic method of determining the I.V. of the polyesters herein is set forth in ASTM method D2857-95.

The diacid residues of the polyesters may be derived from the dicarboxylic acid or a derivative of the diacid such as the lower alkyl esters, e.g., dimethyl terepthalate, acid halides, e.g., diacid chlorides, or, in some cases, anhydrides.

The polyester compositions should contain at least about 0.5 mol % of residues of other dicarboxylic acids or other glycols in order to minimize crystallization of the melt while extruding onto the casting roll, but modifying amounts of such materials should not be more than about 10 mole percent in order to maintain a high melting point in the polymer. Useful modifying monomers include other dicarboxylic acids and/or esters thereof containing about 4 to about 14 carbon atoms and other glycols containing about 2 to about 12 carbon atoms. In some embodiments, modifying acids can include isophthalic acid, 4,4′-biphenyldicarboxylic acid, 5-tert-butylisophthalic acid (CAS #2359-09-3), and/or di-n-butyl-4,4′-sulfonyidibenzoate (CAS#3871-35-5).

In other embodiments, modifying glycols can include ethylene glycol, 1,3-propanediol, 1,6-hexanediol, and neopentyl glycol

The CHDM residues in the polyester compositions may have any combination of cis and trans isomer ratios. Preferably, the CHDM residues have a trans isomer content in the range of about 60 to 100%. A more preferred isomer content is in the range of about 60 to about 80% trans isomer.

Examples of the catalyst materials that may be used in the synthesis of the polyesters utilized in the present invention include titanium, manganese, zinc, cobalt, antimony, gallium, lithium, calcium, silicon, and germanium. Such catalyst systems are described in U.S. Pat. Nos. 3,907,754, 3,962,189, 4,010,145, 4,356,299, 5,017,680, 5,668,243 and 5,681,918, herein incorporated by reference in their entirety. Preferred catalyst metals include titanium and manganese, and most preferred is titanium. The amount of catalytic metal used may range from about 5 to 100 ppm, but the use of catalyst concentrations of about 5 to about 35 ppm titanium is preferred in order to provide polyesters having good color, thermal stability, and electrical properties.

Phosphorus compounds are frequently used in combination with the catalyst metals, and any of the phosphorus compounds normally used in making polyesters may be used. Typically, up to about 100 ppm phosphorus may be used.

Although not required, other additives typically present in polyesters may be used, if desired, so long as they do not hinder the performance of the polyesters used to prepare the films. Such additives may include, but are not limited to, antioxidants, ultraviolet light and heat stabilizers, metal deactivators, colorants, pigments, pinning agents, impact modifiers, nucleating agents, branching agents, flame retardants, and the like.

Branching agents useful in making the polyesters formed within the context of the invention can be ones that provide branching in the acid unit portion of the polyester, or in the glycol unit portion, or it can be a hybrid. Some of these branching agents have already been described herein. However, illustrative of such branching agents are polyfunctional acids, polyfunctional anhydrides, polyfunctional glycols and acid/glycol hybrids. Examples include tri- or tetracarboxylic acids and their corresponding anhydrides, such as trimesic acid, pyromellitic acid, and lower alkyl esters thereof and the like, and tetrols such as pentaerythritol. Also, triols such as trimethylopropane or dihydroxy carboxylic acids and hydroxydicarboxylic acids and derivatives, such as dimethyl hydroxy terephthalate, and the like are useful within the context of this invention. Trimellitic anhydride is a preferred branching agent.

It is preferred that the polyesters utilized in some or all embodiments of the present invention are crystalline or crystallizable and have melting points greater than about 260° C.

The polyester films of the invention may be generated from pellets of a single composition or blends of pellets of several compositions as long as the final film composition fits the composition parameters described above. For example, blends can be made from pure PCT and PCT containing 5% comonomer in various ratios, as long as the final blended composition meets the criteria stated above.

In the first step of a process for preparing the polyester film or sheet material, a melt of the polyester described above can be extruded into an essentially amorphous film at any temperature known in the art, e.g., typically at a temperature of about 270 to 310° C. The thickness of the unstretched (or unoriented) film can typically be in the range of 100 to 2000 microns, more typically about 200 to 1000 microns. The initial film extrusion can be performed by any usual method, including but not restricted to extrusion on a single-screw extruder or extrusion on a twin-screw extruder.

In the second step, the film can be stretched or oriented at stretch ratios above 2× and at stretch temperatures above 90° C. Preferably, in order to reduce the coefficient of thermal expansion of the final stretched film, the cast film is stretched or oriented at stretch ratios and stretch temperatures that satisfy the equation (27*R)−(1.3*(T−Tg))≧27, wherein T is the average of the machine and transverse direction stretch temperatures in degrees Celsius, Tg is the glass transition temperature of the polymer film in degrees Celsius, and R is the average of the machine and transverse direction stretch ratios. The designation “X” refers to the stretch ratio, which is the extent to which the film is stretched relative to the original dimensions of the film. For example, 2× means that the film has been stretched to a dimension that is twice its original dimension. More preferably, the film is stretched at a ratio of about 2.5× to 3× in the machine direction (MD) and about 2.5× to 3× in the transverse direction (TD) at stretching temperatures between Tg and Tg+20° C. Stretching beyond 3× may overstretch and embrittle the film.

After stretching, the film can be heat-set at actual film temperatures from 260° C. to Tm, wherein Tm is the melting point of the polymer as measured by differential scanning calorimetry (DSC), for a period of time greater than about 5 seconds. Note that depending on the heating source of the oven (i.e., convection, radiation, etc.), there may be an amount of time required to heat the film up to 260° C. This time may be up to 30 seconds. This additional time is not included in the heat-set time listed herein, which refers only to the time that the sample actually spends at from 260° C. to Tm. The initial film extrusion can be performed immediately prior to stretching (i.e., in-line), or at a separate time. During heat-setting, the stretched film can be maintained in the stretched dimensions of the film, by means of a tenter frame or other mechanical device that prevents excessive relaxation of the stretched film during heat-setting. During heat-setting, the film can be stretched or relaxed by up to 10%, i.e., the overall dimension of the film can be increased or decreased by up to 10%.

With any of these methods, it is possible to do sequential biaxial stretching, simultaneous biaxial stretching, uniaxial stretching, or combinations thereof. Simultaneous biaxial stretching involves stretching the machine and transverse directions of the film at the same time. In a simultaneous biaxial stretch, the stretch ratio does not have to be the same in the transverse direction as it is in the machine direction. Sequential biaxial stretching involves first stretching in the machine direction, for example, in a roll to roll stretch, and then subsequently stretching in the transverse direction, for example, using a tenter frame. In a sequential stretching process, the two stretches may be performed one immediately after the other (i.e., in line) or at separate times. The machine direction is defined as the long direction of the film, as it is rolled. The transverse direction is defined as the width of the film, i.e, the direction perpendicular to the machine direction. If a sequential biaxial stretch is performed, the stretch ratio and temperature of the stretch do not have to be the same in the transverse direction as it is in the machine direction.

The stretch or oriented polyester film can be heat-set according to known methods. For example, heat-setting may occur in a continuous process such as by passing a roll of stretched film continuously through an oven, or in a batch process such as by individually placing the films in heat-set frames in a heat-setting oven for a fixed length of time. Heat-setting may be performed immediately after stretching (i.e., in-line), or at separate times. The film may be relaxed or expanded by up to 10% during heat-setting.

The number of stretching and heat-setting steps may be varied. The polyester film may be subjected to a single stretch and a single heat-set pass or treatment, a single stretch and multiple heat-set passes, multiple stretches and a single heat-set pass, or multiple stretches and multiple heat-set passes. If multiple stretches and/or heat-set passes are performed, it is possible that the stretches and heat-set passes may alternate in timing, but it is also possible that one heat-set pass may follow a prior heat-set pass without an intervening stretch pass. The conditions of each pass do not have to be the same as the previous pass. For example, the polyester film may be heat-set by a two-stage heat-set process whereby the first heat-set is performed at any actual film temperature above the stretch temperature. Subsequently, the film is heat-set a second time at actual film temperatures in a range of from 260° C. to Tm, wherein Tm is the melting point of the polymer, measured by DSC (differential scanning calorimetry). The polyester film component of the transparent conductive substrate of the present invention can have a final thickness value, i.e., after stretching and heat-setting, of about 12-500 microns.

The conductively coated substrates according to the invention may be used in a variety of applications including a liquid crystal display assembly, an organic light emitting diode display assembly, a photovoltaic device assembly, an architectural window or glazing, and a touch screen display. The coated substrate as a component of the aforementioned devices serves as the electronic conductive component of a display or photovoltaic device. For example, in the case of an amorphous silicon or polycrystalline silicon coated substrate, the coated substrate would constitute the TFT backplane driver for the flat panel display. In the case of a photovoltaic device, the ITO coated substrate would serve as the conductive layer responsible for transporting electrical energy generated by the active component of the photovoltaic device.

This invention can be further illustrated by the following examples of preferred embodiments thereof, although it will be understood that these examples are included merely for purposes of illustration and are not intended to limit the scope of the invention. Unless otherwise indicated, all weight percentages are based on the total weight of the polymer composition and all molecular weights are weight average molecular weights. Also, all percentages are by weight unless otherwise indicated. Unless indicated otherwise, parts are parts by weight, temperature is in degrees C. or is at room temperature, and pressure is at or near atmospheric.

### EXAMPLES

The polyester films and the preparation thereof according to the present invention are further illustrated by the following examples.

In the following examples, film shrinkage/dimensional stability was determined by first measuring the dimensions of a 5.1 cm×5.1 cm (2×2 inch) film sample at two locations in the MD (machine direction) and two locations in the TD (transverse direction). The film sample was then immersed in a solder bath preheated to 260° C. for 10 seconds as described herein. The film was observed for blisters and wrinkles. The dimensions were then measured again. Each dimension after immersion was subtracted from the original dimension and then divided by the original dimension to obtain a % shrinkage. The four % shrinkage values (2 for MD and 2 for TD) were averaged together to obtain the overall % shrinkage.

Glass transition temperatures and melt temperatures were measured using differential scanning calorimetry (DSC) in accordance with ASTM D3418. Each sample of 15.0 mg was sealed in an aluminum pan and heated to 290° C. at a rate of 20° C./minute. The sample was then cooled to below its glass transition at a rate of about 320° C./minute to generate an amorphous specimen. The melt temperature, Tm, corresponds to the peak of the endotherm observed during the scan.

The linear coefficient of thermal expansion (CTE) of the film samples was measured according to IPC-TM-650 2.4.41.3 using a Rheometrics RSA II dynamic mechanical thermal analysis (DMTA) instrument. The procedure was to mount a nominal 2 mm wide by 22 mm long film specimen in the DMTA instrument clamps. The DMTA force was set at a constant 2 grams. The sample was cooled to −10° C., heated to 150° C., re-cooled to −10° C., and then re-heated to 150° C., all at a 10° C./min heating/cooling rate. The length of the sample as a function of temperature was measured during the second heating scan. The sample length-temperature slope was determined over the temperature ranges 25-90° C. and 120-150° C. Two calibrations were performed; one to establish a baseline for the DMTA and one to calibrate the machine response to different standards. Copper, aluminum, and several amorphous plastics with known values of CTE were used as calibration standards. This calibration was then used to calculate the CTE of unknown samples from their measured length-temperature slopes over the temperature ranges 25-90° C. and 120-150° C.

### Example 1 and Comparative Examples C-1-C-3

Example 1 and Comparative Examples C-1-C-3 demonstrate the effect of heat-set temperature on shrinkage of films prepared from PCT.

Pellets of PCT polyester (I.V. 0.74, Tm 293° C., Tg 94° C.) were prepared in a melt-phase polycondensation process using 100 ppm Ti catalyst (as titanium isobutoxide). The pellets were dried at 135° C. for 6 hours and subsequently extruded into 2.032 mm (8 mil) thick films on a Davis Standard 5.1 cm (2.0 inch) extruder equipped with a polyester barrier-type screw. The melt temperature and die temperature were maintained at 293° C. The films were cast onto a 2-roll down-stack with roll temperatures set at 66° C. (150° F.).

The films were then biaxially-oriented on a T.M. Long film stretching machine, with both axes stretched simultaneously and to the same stretch ratio and at the same rate of 35.56 cm (14 inches) per second at the conditions indicated in Table I.

The films were then clamped into an aluminum frame and inserted into a box oven at the set temperature and time indicated in Table I to heat-set them. Two films were placed in the frame, and a thermocouple was sandwiched between the two films to measure the actual film temperature, also shown in Table I. Note that the set temperature was higher than the actual film temperature and that the heat-set time listed includes the time (approximately 30 seconds) required to heat the sample to the actual film temperature.

After heat-setting, the film was immersed for 10 seconds in a solder bath preheated to 260° C., and the resulting % shrinkage is shown in Table I.

Examples C-1-C-3 are comparative examples, produced under a variety of stretching conditions, that demonstrate that heat-setting below a 260° C. actual film temperature can produce films with high levels of shrinkage at 260° C. Blisters had formed in the comparative films during the solder bath immersion. This high degree of shrinkage is generally not acceptable in manufacturing laminates for use in the manufacture of electrical connectors or flexible circuit films.

Note that the film of Comparative Example C-1 was stretched and heat-set under conditions identical to those reported in Example 3 of WO/06125.

Example 1 is an example of a film according to the present invention that has been heat-set at a temperature that produces a film with acceptable shrinkage. The CTE of this film also is acceptable.

In Table I, the stretch ratios refer to stretching in both the machine and transverse directions; temperatures are given in ° C.; time is in seconds; % shrinkage refers to the percentage that the samples of film shrank after being immersed for 10 seconds in a solder bath preheated to 260° C.; CTE values refer to ppm/° C.; and film thickness is given in microns.

TABLE I

Example No.

| | C-1 | C-2 | C-3 | 1 |
|---|---|---|---|---|
| Stretch Temperature | 130 | 100 | 100 | 100 |
| Heat-set Temperature | 250 | 250 | 270 | 290 |
| Heat-set Time | 120 | 60 | 60 | 60 |
| Actual Film Temperature | 236 | 235 | 246 | 274 |
| % Shrinkage | 8.0% | 14.2% | 9.0% | 1.7% |
| CTE (23-90° C.) | — | — | — | 34 |
| CTE (120-150° C.) | — | — | — | 65 |
| Film Thickness | 31 | 51 | 51 | 51 |

### Examples 2-4 and Comparative Examples C-4-C-5

Examples 2-4 were examples of polyester films according to the invention and along with Comparative Examples C-4-C-5 demonstrate the effect of stretch ratio and stretch temperature on shrinkage and CTE of films made from PCT.

Pellets of PCT polyester (I.V. 0.74, Tm 293° C., Tg 94° C.) were prepared into films as described in the prior examples.

The films then were biaxially-oriented on a T.M. Long film stretching machine, with both axes stretched simultaneously and to the same stretch ratio and at the same rate of 35.56 cm (14 inches) per second at the conditions indicated in Table II.

The films were then clamped into an aluminum frame and inserted into a box oven at the heat-set zone set temperature and time shown in Table II to heat-set them. Two films were placed in the frame, and a thermocouple was sandwiched between the two films to measure the actual film temperature, also shown in Table II. Note that the set temperature was higher than the actual film temperature and that the heat set time listed includes the time (approximately 30 seconds) required to heat the sample to the actual film temperature.

The heat-set films were immersed for 10 seconds in a solder bath preheated to 260° C., and the resulting % shrinkage is shown in Table II.

Example 1 is included in Table II for reference.

Examples 1-4 all have acceptable shrinkage and CTE and were stretched under conditions that satisfy the equation (27*R)−(1.3*(T−Tg))≧27, where T is the average of the machine and transverse direction stretch temperatures in degrees Celsius, Tg is the glass transition temperature of the polymer film in degrees Celsius, and R is the average of the machine and transverse direction stretch ratios. These films were heat-set at actual film temperatures of 260° C. or greater.

Comparative Examples C-4 and C-5 were stretched at conditions that do not satisfy the equation (27*R)−(1.3*(T−Tg))≧27 and have unacceptable CTE values. Note that the film of Comparative Example C-5 was stretched and heat-set under conditions identical to those reported in Example 2 of WO/06125.

It is also noteworthy that Examples 3 and 4 were acceptable, even though WO/06125 explicitly states that “PCT behaves differently than PET in that once the film is stretched beyond 2.5×, no amount of heat-setting (time or temperature) can anneal the internal stresses generated during the stretching process.

TABLE II

| | Example No. | | | | | |
|---|---|---|---|---|---|---|
| | 1 | 2 | C-4 | C-5 | 3 | 4 |
| Stretch Temperature | 100 | 100 | 130 | 130 | 130 | 130 |
| Heat-set Temperature | 290 | 290 | 290 | 280 | 290 | 290 |
| Heat-set Time | 60 | 60 | 120 | 120 | 60 | 60 |
| Actual Film Temperature | 274 | 272 | 279 | 260 | 276 | 269 |
| % Shrinkage | 1.7% | 2.5% | 1.7% | 1.4% | 1.5% | 2.7% |
| CTE (23-90° C.) | 34 | 29 | 57 | 47 | 42 | 33 |
| CTE (120-150° C.) | 65 | 51 | 146 | 100 | 80 | 61 |
| Film Thickness | 51 | 31 | 51 | 31 | 23 | 15 |

### Examples 5-8 and Comparative Examples C-6-C-9

Examples 5-8 and Comparative Examples C-6-C-9 of Table III demonstrate the effect of heat-set temperature and time on shrinkage and CTE of films made from PCT using a sequential stretch and tenter process.

Pellets of PCT polyester (I.V. 0.74, Tm 293° C., Tg 94° C.) were prepared in a melt-phase polycondensation process using 100 ppm Ti catalyst (as titanium isobutoxide). The pellets were dried at 120° C. for 16 hours and subsequently extruded into 0.460 mm (18 mil) thick sheeting on a Davis Standard 6.4 cm (2.5 inch) extruder equipped with a polyester barrier-type screw. The melt temperature and die temperature were maintained at 300° C. The films were cast onto a 3-roll down-stack with roll temperatures set at 49° C./57° C./66° C. (120° F./135° F./150° F.) from top to bottom, respectively.

The films were then stretched and tentered on a commercial tenter apparatus with the machine direction stretched on a roll stack at the ratio and temperature shown in Table III and the transverse direction subsequently stretched between clips in a tenter frame at the conditions shown in Table III. The films were immediately passed into an annealing zone, which provided the first heat-set treatment or pass. This annealing zone was set at the heat-set zone set temperature and time indicated in Table III. Actual film temperatures in the annealing zone were obtained by placing a temperature indicating tape onto the film. This tape changes color at a series of known temperatures to indicate the maximum temperature the film experienced.

In Example 7 and Comparative Examples C-8 and C-9, a second heat-set treatment was performed by clamping the films into an aluminum frame, which was then inserted into a box oven at the heat-set zone set temperature and time indicated in Table III. For these examples, two films were placed in the frame, and a thermocouple was sandwiched between the two films to measure the actual film temperature.

In Example 8, a second heat-set treatment was performed by passing the film a second time through the annealing zone of the tenter frame at the heat-set zone set temperature and time indicated in Table III. The actual film temperature listed was the highest temperature attained during the combination of first and second heat-set. Note that the set temperature was higher than the actual film temperature and that the heat-set time listed includes the time required to heat the sample to the actual film temperature. Because of the time required for the film to heat up, the actual film temperature shown was a function of both set temperature and time. The heat-set film was immersed for 10 seconds in a solder bath preheated to 260° C., and the resulting % shrinkage is shown in Table III.

Comparative Examples C-6-C-9 show how actual film temperatures below 260° C. can provide insufficient shrinkage at 260° C. The films of Examples 5-8 have acceptable shrinkage and CTE.

In Table III, MD stretch ratios refer to stretching in the machine direction; TD stretch ratios refer to stretching in the transverse direction; Temperatures are given in ° C.; time is in seconds; n/a means that a second heat-set treatment was not performed; % shrinkage refers to the percentage that the samples of film shrank after being immersed for 10 seconds in a solder bath preheated to 260° C.; CTE values refer to ppm/° C.; and film thickness is given in microns.

TABLE III

| | Example No. | | | | | | | |
|---|---|---|---|---|---|---|---|---|
| | C-6 | C-7 | 5 | 6 | C-8 | C-9 | 7 | 8 |
| MD Stretch Ratio | 2.5 | 2.5 | 2.5 | 2.5 | 2.5 | 2.5 | 2.5 | 2.5 |
| MD Temperature | 91 | 91 | 91 | 91 | 91 | 91 | 91 | 91 |
| TD Stretch Ratio | 2.5 | 2.5 | 2.5 | 2.5 | 2.5 | 2.5 | 2.5 | 2.5 |
| TD Temperature | 99 | 99 | 99 | 99 | 99 | 99 | 99 | 99 |
| 1st Heat-Set | 288 | 304 | 304 | 304 | 288 | 288 | 288 | 288 |
| Temperature | | | | | | | | |
| 1st Heat-Set Time | 9 | 13 | 35 | 106 | 9 | 9 | 9 | 9 |
| 2nd Heat-Set | n/a | n/a | n/a | n/a | 270 | 290 | 290 | 299 |
| Temperature | | | | | | | | |
| 2nd Heat-Set Time | n/a | n/a | n/a | n/a | 60 | 9 | 60 | 33 |
| Actual Film Temp | 200 | 245 | 260 | 267 | 248 | 200 | 275 | 271 |
| Solder Bath | 9.9% | 4.9% | 2.4% | 0.9% | 5.3% | 12.6% | 0.9% | 1.2% |
| % Shrinkage | | | | | | | | |
| CTE (23-90° C.) | 24 | 34 | 37 | 31 | 30 | 23 | 33 | 42 |
| CTE (120-150° C.) | 37 | 59 | 72 | 75 | 50 | 44 | 81 | 71 |
| Film Thickness | 75 | 75 | 75 | 75 | 75 | 75 | 75 | 75 |

Abbreviations, analytical procedures, and experimental equipment used in Examples 9-12 are provided below:
DMN: 2,6-dimethylnaphthalate
DMBDC: 4,4′-dimethylbiphenyldicarboxylate
BDC: 4,4′-biphenyldicarboxylate
DMT: dimethylterephthalate
N: 2,6-naphthalenedicarboxylic acid units
T: terephthalic acid units
CHDM: 1,4-cyclohexanedimethanol
IV: Inherent viscosity determined at were measured at a temperature of 25° C. at 0.5 g/dL concentration in a solvent mixture of symmetric tetrachloroethane and phenol having a weight ratio of symmetric tetrachloroethane to phenol of 2:3.
Tm: Melting temperature determined on the first cycle differential scanning calorimeter (DSC) run at a heating rate of 20° C./minute.
Tg: Glass transition temperature was determined on the 2nd cycle DSC run at a heating rate of 20° C./minute.
Final copolyester compositions were determined by proton NMR analysis on a 600 MHz JEOL instrument.

### Example 9

Preparation of N10BDC(CHDM): 67.23 grams (0.275 moles) of DMN, 8.27 grams (0.031 moles) of DMBDC, 46.75 grams (0.324 moles) of CHDM were added to a 500 ml single neck round bottom flask. The catalyst system comprised 100 ppm titanium added upfront. The flask was immersed in a Belmont metal bath that was preheated to 290° C. The temperature set point was increased to 315° C. after 7 minutes, and the theoretical amount of methanol was collected. When the temperature reached 320° C., the pressure in the flask was then gradually reduced from atmospheric to 0.3 mm of Hg. Stirring was reduced as the viscosity increased until a stir rate of 40 rpm was obtained. The reaction conditions were held for 9 minutes. The vacuum was discontinued and nitrogen was bled into the flask. The polymer was allowed to solidify by cooling to a temperature below Tg, removed from the flask, and ground to pass through a 3 mm screen. The inherent viscosity of the polymer was 0.774. The polymer had first cycle melting point of 310° C. The polymer had a Tg of 108° C. and a second cycle melting point of 306.4° C. Compositional analysis (by NMR) showed the copolyester contained 90.4 mol % N and 9.6 mol % BDC.

A sample of the polymer was compression-molded into a film. The final film was transparent and colorless. The film was then biaxially-oriented on a T.M. Long film stretching machine, with both axes stretched simultaneously to a 3× stretch ratio at the same rate of 35.56 cm (14 inches) per second at a stretch temperature of 155° C. after a soak time of 30 seconds. The stretched film was then clamped into an aluminum frame and inserted into a box oven at 274° C. for 30 seconds to heat-set it. After heat-setting, the film is immersed for 10 seconds in a solder bath preheated to 260° C., and the resulting % shrinkage was 1.56%.

Example 9 is an example of film according to the present invention that has been heat-set at a temperature that produces a film with acceptable shrinkage.

### Example 10

Preparation of N5BDC(CHDM): 71.25 grams (0.292 moles) of DMN, 4.15 grams (0.015 moles) of DMBDC, 46.94 grams (0.325 moles) of CHDM were added to a 500 ml single neck round bottom flask. The catalyst system comprised 100 ppm titanium added upfront. The flask was immersed in a Belmont metal bath that was preheated to 290° C. The temperature set point was increased to 300° C. after 5 minutes and to 320° C. after an additional 7 minutes. The theoretical amount of methanol was collected. When the temperature reached 320° C., the pressure in the flask was then gradually reduced from atmospheric to 0.5 mm of Hg. Stirring was reduced as the viscosity increased until a stir rate of 40 rpm was obtained. The reaction conditions were held for 20 minutes. The vacuum was discontinued and nitrogen was bled into the flask. The polymer was allowed to solidify by cooling to a temperature below Tg, removed from the flask, and ground to pass through a 3 mm screen. The inherent viscosity of the polymer was 0.666. The polymer had first cycle melting point of 313° C. The polymer had a Tg of 121.81° C. and a second cycle melting point of 314° C. Compositional analysis (by NMR) showed the copolyester contained 95.1 mol % N and 4.9 mol % BDC.

### Example 11

Preparation of N10T(CHDM): 68.83 grams (0.280 moles) of DMN, 6.10 grams (0.03 moles) of DMT, 47.87 grams (0.330 moles) of CHDM were added to a 500 ml single neck round bottom flask. The catalyst system comprised 100 ppm titanium added upfront. The flask was immersed in a Belmont metal bath that was preheated to 290° C. The temperature set point was increased to 320° C. after 5 minutes and the theoretical amount of methanol was collected. When the temperature reached 320° C., the pressure in the flask was then gradually reduced from atmospheric to 0.5 mm of Hg. Stirring was reduced as the viscosity increased until a stir rate of 40 rpm was obtained. The reaction conditions were held for 30 minutes. The vacuum was discontinued and nitrogen was bled into the flask. The polymer was allowed to solidify by cooling to a temperature below Tg, removed from the flask, and ground to pass through a 3 mm screen. The inherent viscosity of the polymer was 0.541. The polymer had first cycle melting point of 312.2° C. The polymer had a Tg of 102.4° C. and a second cycle melting point of 304.48° C. Compositional analysis (by NMR) showed the copolyester contained 90.2 mol % N and 9.8 mol % T.

### Example 12

Preparation of N5T(CHDM): 72.09 grams (0.30 moles) of DMN, 3.00 grams (0.02 moles) of DMT, 47.49 grams (0.33 moles) of CHDM were added to a 500 ml single neck round bottom flask. The catalyst system comprised 100 ppm titanium added upfront. The flask was immersed in a Belmont metal bath that was preheated to 290° C. The temperature set point was increased to 320° C. after 6 minutes and the theoretical amount of methanol was collected. When the temperature reached 320° C., the pressure in the flask was then gradually reduced from atmospheric to 0.5 mm of Hg. Stirring was reduced as the viscosity increased until a stir rate of 40 rpm was obtained. The reaction conditions were held for 30 minutes. The vacuum was discontinued and nitrogen was bled into the flask. The polymer was allowed to solidify by cooling to a temperature below Tg, removed from the flask, and ground to pass through a 3 mm screen. The inherent viscosity of the polymer was 0.492. The polymer had first cycle melting point of 308.0° C. The polymer had a Tg of 105.8° C. and a second cycle melting point of 299.4° C. Compositional analysis (by NMR) showed the copolyester contained 91.3 mol % N and 8.7 mol % T.

### Example 13

Preparation of N25BDC(CHDM): 55.36 grams (0.227 moles) of DMN, 20.42 grams (0.076 moles) of DMBDC, 46.20 grams (0.320 moles) of CHDM were added to a 500 ml single neck round bottom flask. The catalyst system consisted of 100 ppm titanium added upfront. The flask was immersed in a Belmont metal bath that was preheated to 245° C. After the theoretical amount of methanol was collected, the temperature set point was increased to 300° C. When the temperature reached 300° C., the pressure in the flask was then gradually reduced from atmospheric to 0.5 mm of Hg. Stirring was reduced as the viscosity increased until a stir rate of 40 rpm was obtained. The reaction conditions were held for 30 minutes. The vacuum was discontinued and nitrogen was bled into the flask. The polymer was allowed to solidify by cooling to a temperature below Tg, removed from the flask and ground to pass through a 3 mm screen. The inherent viscosity of the polymer was 0.876. The polymer had first cycle melting point of 291.1° C. The polymer had a Tg of 131.2° C. and a second cycle melting point of 292.4° C. Compositional analysis (by NMR) showed the copolyester contained 75.0 mol % N and 25.0 mol % BDC. A sample was compression molded into a film. The polymer film was biaxially oriented with a 3×3 stretch ratio on a TM Long stretcher and a planar stretch ratio of approximately 3.84 was observed. The final film was transparent and colorless.

### Example 14

Preparation of N10BDC(CHDM): 67.23 grams (0.275 moles) of DMN, 8.27 grams (0.031 moles) of DMBDC, 46.75 grams (0.324 moles) of CHDM were added to a 500 ml single neck round bottom flask. The catalyst system consisted of 100 ppm titanium added upfront. The flask was immersed in a Belmont metal bath that was preheated to 290° C. The temperature set point was increased to 315° C. after 7 minutes and the theoretical amount of methanol was collected. When the temperature reached 320° C., the pressure in the flask was then gradually reduced from atmospheric to 0.3 mm of Hg. Stirring was reduced as the viscosity increased until a stir rate of 40 rpm was obtained. The reaction conditions were held for 9 minutes. The vacuum was discontinued and nitrogen was bled into the flask. The polymer was allowed to solidify by cooling to a temperature below Tg, removed from the flask and ground to pass through a 3 mm screen. The inherent viscosity of the polymer was 0.774. The polymer had first cycle melting point of 310.2° C. The polymer had a Tg of 107.5° C. and a second cycle melting point of 306.4° C. Compositional analysis (by NMR) showed the copolyester contained 90.4 mol % N and 9.6 mol % BDC. A sample of the polymer was compression molded into a film. The film was biaxially oriented on a TM Long stretcher and a planar stretch ratio of approximately 3.99 was observed. The final film was transparent and colorless.

### Example 15

Preparation of N5BDC(CHDM): 71.25 grams (0.292 moles) of DMN, 4.15 grams (0.015 moles) of DMBDC, 46.94 grams (0.325 moles) of CHDM were added to a 500 ml single neck round bottom flask. The catalyst system consisted of 100 ppm titanium added upfront. The flask was immersed in a Belmont metal bath that was preheated to 290° C. The temperature set point was increased to 300° C. after 5 minutes and to 320° C. after an additional 7 minutes. The theoretical amount of methanol was collected. When the temperature reached 320° C., the pressure in the flask was then gradually reduced from atmospheric to 0.5 mm of Hg. Stirring was reduced as the viscosity increased until a stir rate of 40 rpm was obtained. The reaction conditions were held for 20 minutes. The vacuum was discontinued and nitrogen was bled into the flask. The polymer was allowed to solidify by cooling to a temperature below Tg, removed from the flask and ground to pass through a 3 mm screen. The inherent viscosity of the polymer was 0.666. The polymer had first cycle melting point of 313.1° C. The polymer had a Tg of 121.81° C. and a second cycle melting point of 313.7° C. Compositional analysis (by NMR) showed the copolyester contained 95.1 mol % N and 4.9 mol % BDC. The final film was transparent and colorless.

### Example 16

Preparation of N25T(CHDM): 58.74 grams (0.240 moles) of DMN, 15.60 grams (0.08 moles) of DMT, 49.02 grams (0.340 moles) of CHDM were added to a 500 ml single neck round bottom flask. The catalyst system consisted of 100 ppm titanium added upfront. The flask was immersed in a Belmont metal bath that was preheated to 245° C. The temperature set point was immediately increased to 300° C. and the theoretical amount of methanol was collected. When the temperature reached 300° C., the pressure in the flask was then gradually reduced from atmospheric to 0.5 mm of Hg. Stirring was reduced as the viscosity increased until a stir rate of 40 rpm was obtained. The reaction conditions were held for 25 minutes. The vacuum was discontinued and nitrogen was bled into the flask. The polymer was allowed to solidify by cooling to a temperature below Tg, removed from the flask and ground to pass through a 3 mm screen. The inherent viscosity of the polymer was 0.912. The polymer had first cycle melting point of 285.2° C. The polymer had a Tg of 120.4° C. and a second cycle melting point of 288.2° C. Compositional analysis (by NMR) showed the copolyester contained 75.5 mol % N and 24.5 mol % T A sample of the polymer was compression molded into a film. The polymer film was biaxially oriented on a TM Long stretcher and a planar stretch ratio of approximately 3.77 was observed. The final film was transparent and colorless.

The invention has been described in detail with particular reference to preferred embodiments thereof, but it will be understood that variations and modifications can be effected within the spirit and scope of the invention

We claim:

1. A film capable of being coated with a conductive coating at temperatures equal to or greater than 240° C., said film comprising a biaxially-oriented polyester film that is produced from a polyester having a melting point of 260° C. or greater.

2. A film capable of being coated with a conductive coating at temperatures equal to or greater than 240° C., said film comprising a biaxially-oriented polyester film that is produced from a polyester comprising:
(a) diacid residues comprising from about 90 to about 99.5 mole percent of terephthalic acid residues, naphthalenedicarboxylic acid residues, or combinations thereof; and
(b) diol residues comprising at least 90 mole percent of 1,4-cyclohexanedimethanol residues,
wherein the polyester comprises a total of 100 mole percent diacid residues and a total of 100 mole percent diol residues, and wherein the polyester has a melting point of 260° C. or greater.

3. The film according to claim 2, which has been stretched at stretch ratios above 2.0 times and stretch temperatures above 90° C.

4. The film according to claim 3, which has been stretched biaxially at conditions that satisfy the equation (27*R)−(1.3*(T−Tg))≧27, where T is the average of the machine and transverse direction stretch temperatures in degrees Celsius, Tg is the glass transition temperature of the polymer film in degrees Celsius, and R is the average of the machine and transverse direction stretch ratios; and which has been heat-set at an actual film temperature of from 250° C. to Tm, where Tm is the melting point of the polymer as measured by differential scanning calorimetry (DSC).

5. The film according to claim 2, which has been stretched between 2.5 and 3.0 times, at a temperature between Tg and Tg+20° C.; and which has been heat-set at an actual film temperature of 250° C. or greater.

6. A transparent conductively coated substrate comprising:
(a) a transparent conductive inorganic oxide layer; and
(b) a biaxially-oriented polyester film that is produced from a polyester comprising:
(i) diacid residues comprising from about 90 to about 99.5 mole percent of terephthalic acid residues, naphthalenedicarboxylic acid residues, or combinations thereof; and
(2) diol residues comprising at least 90 mole percent of 1,4-cyclohexanedimethanol residues,
wherein the polyester comprises a total of 100 mole percent diacid residues and a total of 100 mole percent diol residues, and has a melting point of 260° C. or greater.

7. The substrate according to claim 6, wherein the transparent conductive layer is indium tin oxide.

8. The substrate according to claim 6, wherein the polyester film comprises diacid residues comprising between about 95 and about 99.5 mole percent of terephthalic acid residues.

9. The substrate according to claim 6, wherein the polyester film comprises diacid residues comprising between about 90 and about 99 mole percent of naphthalenedicarboxylic acid residues.

10. The substrate according to claim 6, wherein the transparent conductive layer was applied at a temperature greater than about 235° C.

11. The substrate according to claim 6, wherein the transparent conductive layer was applied at a temperature greater than about 250° C.

12. A liquid crystal display assembly comprising the substrate according to claim 6.

13. An organic light emitting diode display assembly comprising the substrate according to claim 6.

14. A photovoltaic device assembly comprising the substrate according to claim 6.

15. An architectural window or glazing comprising the substrate according to claim 6.

16. A touch screen display comprising the substrate according to claim 6.

17. A transparent conductively coated substrate comprising:
(a) a transparent conductive inorganic oxide layer; and
(b) a biaxially-oriented polyester film that is produced from a polyester comprising of:
(i) diacid residues comprising from about 90 to about 99.5 mole percent of terephthalic acid residues, naphthalenedicarboxylic acid residues, or combinations thereof; and
(ii) diol residues comprising at least 90 mole percent of 1,4-cyclohexanedimethanol residues,
wherein the polyester comprises a total of 100 mole percent diacid residues and a total of 100 mole percent diol residues, and has a melting point of 260° C. or greater;
wherein the polyester film has been stretched at stretch ratios and stretch temperatures that satisfy the equation (27*R)−(1.3*(T−Tg))≧27, where T is the average of the machine and transverse direction stretch temperatures in degrees Celsius, Tg is the glass transition temperature of the polymer film in degrees Celsius, and R is the average of the machine and transverse direction stretch ratios; and
wherein the stretched polyester film has been heat-set at an actual film temperature of from 250° C. to Tm, where Tm is the melting point of the polymer as measured by differential scanning calorimetry (DSC), for a time between 1 and 120 seconds, while maintaining the dimensions of the stretched film.

18. The substrate according to claim 17, wherein the transparent conductive layer is indium tin oxide.

19. The substrate according to claim 17, wherein the polyester film comprises diacid residues comprising between about 95 and about 99.5 mole percent of terephthalic acid residues.

20. The substrate according to claim 17, wherein the polyester film comprises diacid residues comprising between about 90 and about 99 mole percent of naphthalenedicarboxylic acid residues.

21. A liquid crystal display assembly comprising the substrate according to claim 17.

22. An organic light emitting diode display assembly comprising the substrate according to claim 17.

23. A photovoltaic device assembly comprising the substrate according to claim 17.

24. An architectural window or glazing comprising the substrate according to claim 17.

25. A touch screen display comprising the substrate according to claim 17.

26. A conductively coated substrate comprising:
(a) an amorphous silicon or polycrystalline silicon conductive layer; and
(b) a biaxially-oriented polyester film that is produced from a polyester comprising:
(1) diacid residues comprising from about 90 to about 99.5 mole percent of terephthalic acid residues, naphthalenedicarboxylic acid residues, or combinations thereof; and
(2) diol residues comprising at least 90 mole percent of 1,4-cyclohexanedimethanol residues,
wherein the polyester comprises a total of 100 mole percent diacid residues and a total of 100 mole percent diol residues, and has a melting point of 260° C. or greater.

27. The substrate according to claim 26, wherein the conductive layer is amorphous silicon.

28. The substrate according to claim 26, wherein the polyester film comprises diacid residues comprising between about 95 and about 99.5 mole percent of terephthalic acid residues.

29. The substrate according to claim 26, wherein the polyester film comprises diacid residues comprising between about 90 and about 99 mole percent of naphthalenedicarboxylic acid residues.

30. The substrate according to claim 26, wherein the conductive layer was applied at a temperature greater than about 235° C.

31. The substrate according to claim 26, wherein the conductive layer was applied at a temperature greater than about 250° C.

32. A liquid crystal display assembly comprising the substrate according to claim 26.

33. An organic light emitting diode display assembly comprising the substrate according to claim 26.

34. A photovoltaic device assembly comprising the substrate according to claim 26.

35. An architectural window or glazing comprising the substrate according to claim 26.

36. A touch screen display comprising the substrate according to claim 26.

37. A conductively coated substrate comprising:
(a) an amorphous silicon or polycrystalline silicon conductive layer; and
(b) a biaxially-oriented polyester film that is produced from a polyester comprising:
(i) diacid residues comprising from about 90 to about 99.5 mole percent of terephthalic acid residues, naphthalenedicarboxylic acid residues, or combinations thereof; and
(ii) diol residues comprising at least 90 mole percent of 1,4-cyclohexanedimethanol residues,
wherein the polyester comprises a total of 100 mole percent diacid residues and a total of 100 mole percent diol residues, and has a melting point of 260° C. or greater;
wherein the polyester film has been stretched at stretch ratios and stretch temperatures that satisfy the equation (27*R)−(1.3*(T−Tg))≧27, where T is the average of the machine and transverse direction stretch temperatures in degrees Celsius, Tg is the glass transition temperature of the polymer film in degrees Celsius, and R is the average of the machine and transverse direction stretch ratios; and
wherein the stretched polyester film has been heat-set at an actual film temperature of from 250° C. to Tm, where Tm is the melting point of the polymer as measured by differential scanning calorimetry (DSC), for a time between 1 and 120 seconds, while maintaining the dimensions of the stretched film.

38. The substrate according to claim 37, wherein the conductive layer is amorphous silicon.

39. The substrate according to claim 37, wherein the polyester film comprises diacid residues comprising between about 95 and about 99.5 mole percent of terephthalic acid residues.

40. The substrate according to claim 37, wherein the polyester film comprises diacid residues comprising between about 90 and 99 mole percent of naphthalenedicarboxylic acid residues.

41. A liquid crystal display assembly comprising the substrate according to claim 37.

42. An organic light emitting diode display assembly comprising the substrate according to claim 37.

43. A photovoltaic device assembly comprising the substrate according to claim 37.

44. An architectural window or glazing comprising the substrate according to claim 37.

45. A touch screen display comprising the substrate according to claim 37.
